(19) United States
(12) Patent Application Publication
(10) Pub. No.: US 2017/0135523 A1
(43) Pub. Date: May 18, 2017

(54) DEEP FRYING BASKET OIL SHIELD

(71) Applicant: Rory Chesley Patrick Millikin, Kelowna (CA)

(72) Inventor: Rory Chesley Patrick Millikin, Kelowna (CA)

(21) Appl. No.: 14/944,168

(22) Filed: Nov. 17, 2015

(51) Int. Cl. A47J 37/12

(52) U.S. Cl. CPC A47J 37/1295

(57) ABSTRACT

Methods and apparatus for making fryers safer are disclosed. Presented methods and devices in accordance with the present disclosure generally comprise foldable or non-foldable shields that may be temporarily or permanently attached to deep frying baskets. Disclosed shields may also be attached to household cooking objects such as skillets and frying pans.

### CROSS-REFERENCE(S) TO RELATED APPLICATION(S)

None

### TECHNICAL FIELD

This application relates generally to deep fryers and more particularly, to a shield for protecting user's hand while deep frying.

### BRIEF DESCRIPTION OF THE DRAWINGS

The drawings, when considered in connection with the following description, are presented for the purpose of facilitating an understanding of the subject matter sought to be protected.

FIG. 1 is an isometric view of an example fryer basket for deep frying;

FIG. 2A is a front isometric view of a fryer basket with an example oil shield;

FIG. 2B is a back isometric view of a fryer basket with an example oil shield;

FIG. 3 is an isometric view of a fryer basket with a folded example oil shield;

FIG. 4 is an isometric view of an example foldable oil shield; and

FIG. 5 is an isometric view of a fryer basket with yet another example oil shield.

### DETAILED DESCRIPTION

While the present disclosure is described with reference to several illustrative embodiments, it should be clear that the present disclosure is not limited to such embodiments. Therefore, the description of the embodiments provided herein is illustrative of the present disclosure and should not limit the scope of the disclosure as claimed. In addition, while the following description references an oil fryer such as those for Onion Ring and French Fries, it will be appreciated that the disclosure may include other types of food fryers, and hot liquid containers in general.

A popular method of cooking is to fry or deep fry many food items. A brief list of foods that may be deep fried include various vegetables, french fries, potato chips, chicken, pork, beef, candy bars, ice cream, etc. Many other types of food are amenable to deep frying. Deep frying generally involves immersing the food item in a high-temperature fat-based solution, such as in cooking oil (e.g., canola oil, peanut oil, vegetable oil, olive oil, liquefied shortening, etc.) until the food is cooked, though other liquids such as water or even air can be used.

While fried foods and the fryers used to cook the fired foods are popular, the temperatures found in the frying liquids are quite high, often greater than 300 degrees Fahrenheit. Customarily, food, such as potatoes and chicken parts, are placed in metal baskets and are lowered by hand into the hot liquid and left to be cooked. Thus, splashing hot liquid, for example as a result of objects falling into the liquid, may accidentally land on body parts, specially hands, and cause severe injuries. Therefore, an apparatus for preventing the hot scatterring liquid from reaching the user's hand is desirable.

As set forth in the detailed description, in accordance with various embodiments of the present disclosure systems, methods and apparatuses are provided for making fryers safer. With reference to the figures attached hereto, methods and devices in accordance with the present disclosure generally comprise foldable or non-foldable shields that may be temporarily or permanently attached to the body/basket or to the handle of fryer baskets. These shields may be made from plastic, metal, wood, or other natural or synthetic materials.

In addition to safety, another advantage of the present disclosure is the easy and cost effective retrofitting of the existing fryer baskets. The following disclosed embodiments may be described in terms of functional components and/or various processing steps. Each functional component may include any number of parts configured to perform specified functions and achieve various results. Those skilled in art will recognize that the disclosed apparatus and/or method are not limited to food preparation and may be used for protecting against serious injuries while working with any hot or dangerous liquid.

The detailed description herein makes use of various exemplary embodiments to assist in disclosing the present invention. While these exemplary embodiments are described in sufficient detail to enable those skilled in the art to practice the invention, it should be understood that other embodiments may be realized and that different combinations and modifications of structures, arrangements, applications, proportions, elements, materials, or components used in the practice of the present disclosure, in addition to those not specifically recited, can be varied or otherwise particularly adapted to specific environments, manufacturing specifications, design parameters or other operating requirements without departing from the scope of the present disclosure and are intended to be included in this disclosure. Thus, the detailed description herein is presented for purposes of illustration only and not of limitation.

In accordance with an exemplary embodiment of the present disclosure, the system, methods, and devices disclosed herein discuss frying foods and the safety considerations related thereto. The terms “cooking” and “frying” and formatives thereof may be used interchangeably herein. Other mechanisms and devices for cooking food besides frying fall within the scope of the present disclosure, such as boiling, blanching, steaming, poaching, simmering, steeping, and the like. For consistency, “frying” will be used throughout without limiting the methods of cooking for use in conjunction with embodiments of the present disclosure.

Additionally, in certain embodiments water may be used in place of cooking oil in order to boil, poach, blanch or otherwise cook certain foods. The foods are housed within the basket and cooked in the heated water in a water chamber, where the water chamber takes the place of the oil chamber. Such foods that may be cooked by this process comprise pasta products and vegetables.

Examples of heating mechanisms used in connection with maintaining and regulating the temperature of the oil in accordance with the present disclosure include, but are not limited to, various gas and electric heating elements, as well as other now known or as yet unknown heating mechanism suitable for heating oil.

According to various exemplary embodiments of the present invention, devices used herein are available in numerous sizes and/or capacities. For example, the device may be available in commercial sizes for use by restaurants and other food-frying establishments and large food manufacturers and producers that must produce hundreds, if not thousands, of pounds of fried food every day. Commercial devices may range in size depending on the desired capacity for the device. Other embodiments of the invention provide a device that is amenable to use by smaller businesses and food stands, or even in a user's home. For example, devices in accordance with the present invention may be configured to be easily “retrofit” to existing kitchen cooking devices and appliances such as skillets. Those skilled in the art will appreciate that various embodiments of the present invention can comprise floor model, ventless countertop models, pressure fryer models, and home models.

Moreover, such a device for personal use may produce as little as one serving of food and may be configured to be placed on a countertop. The materials used for the various components described herein may be various heat resistant materials, such as high temperature plastics, ceramics, metals, and the like that will not be detrimentally effected by the temperature of the oil and heating elements described herein. All sizes and capacities of devices discussed are contemplated within the scope of the present invention.

Devices in accordance with the present disclosure are generally readily cleanable. For example, in some embodiments the various components, such as the shields disclosed herein, are removable or hinged to facilitate ease of cleaning. For example, the shield may be rotatable on a hinge to provide access to locations that are otherwise difficult to reach and clean. In other embodiments, components of or the entire shield may be removable to facilitate cleaning.

The baskets of the various embodiments disclosed herein may be of any shape or size (e.g., circular, square, rectangular or otherwise). This deposit may occur in any suitable way. For example, food may simply be deposited manually by an operator into the basket. Alternatively, the depositing of the food may be automated, for example via robotic/mechanical arms, conveyors and transport mechanisms which transport the food. In various embodiments, baskets in accordance with the present invention may be designed for specific food types, such as baskets with vertical basket slots for “planar” foods (e.g., hash brown patties, chicken patties, etc.). For example, for hash brown patties, it may be desirable to keep the patties upright.

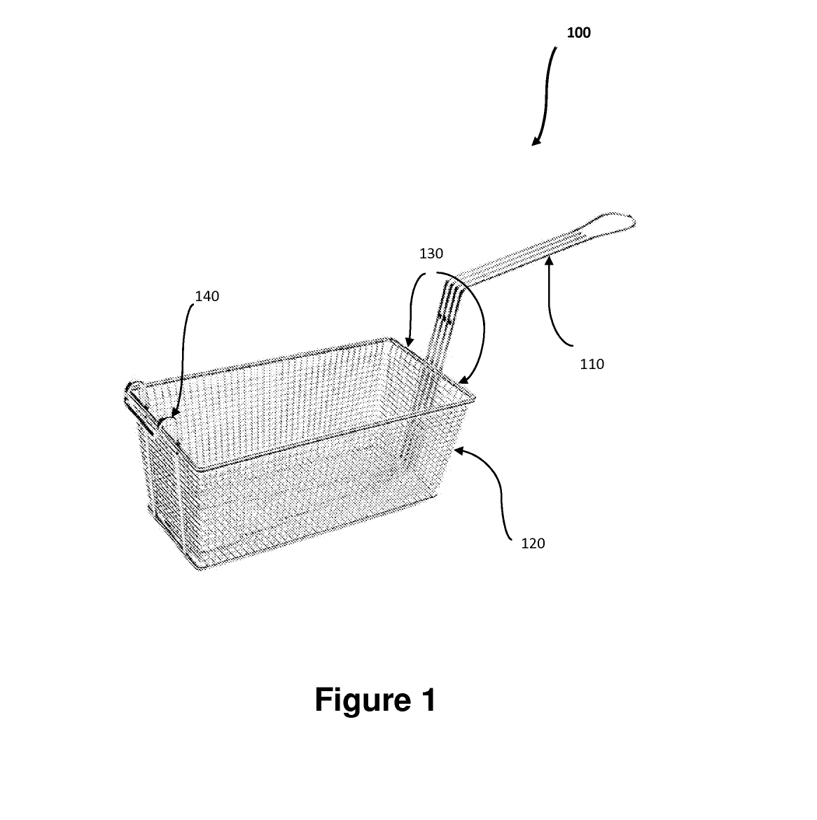

FIG. 1 illustrates a fryer basket 100 comprising a handle 110, a metal basket/container 120, which itself includes a reinforced outer edge 130, and a hook 140 for hanging the basket for example on the side of a fryer oil-bay. Customarily, all parts of fryer basket 100 are made of stainless steel. Food is placed in basket 120 and is lowered into the hot oil until the oil completely covers the food at which point fryer basket 100 is left partially or fully submerged for a predetermined length of time, by hanging it on a side of the fryer oil-bay.

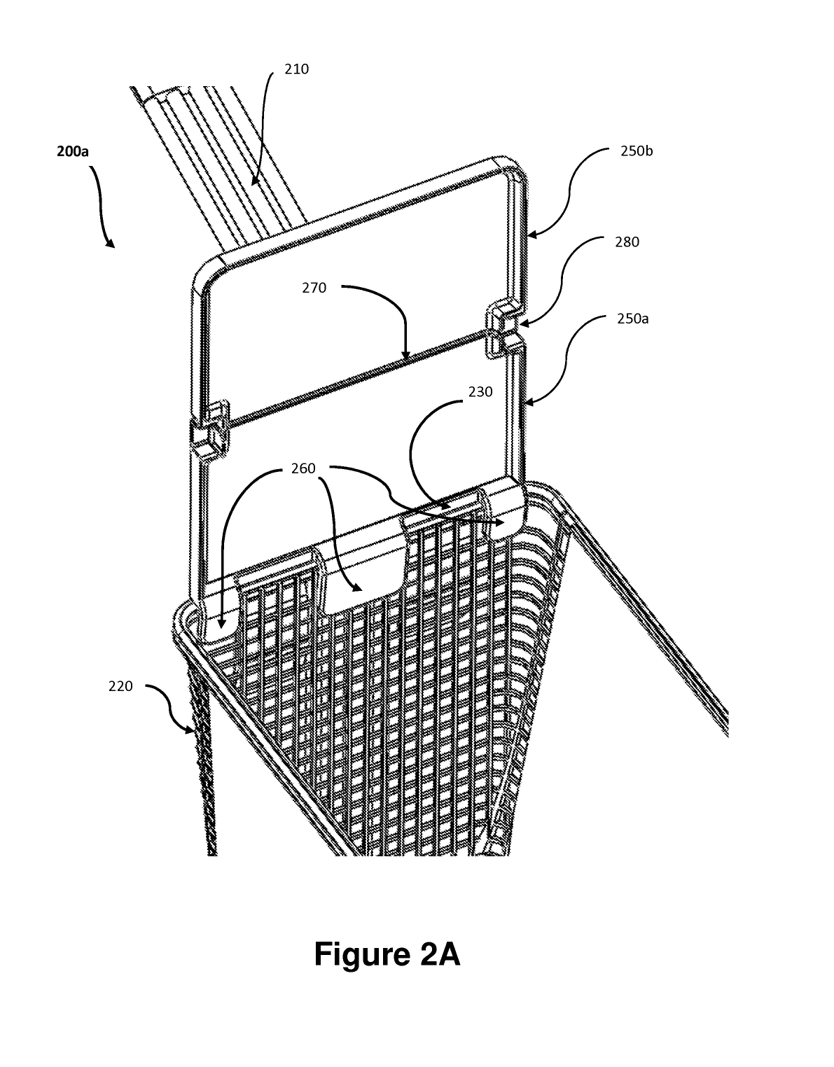

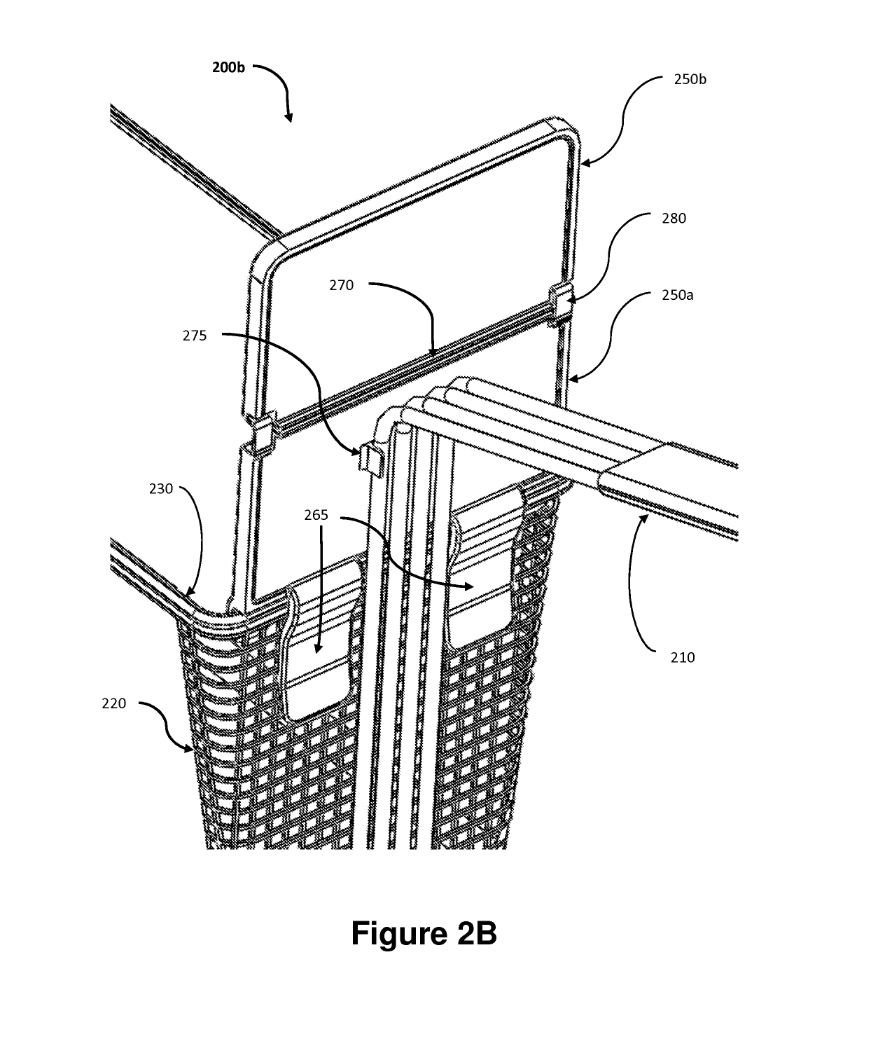

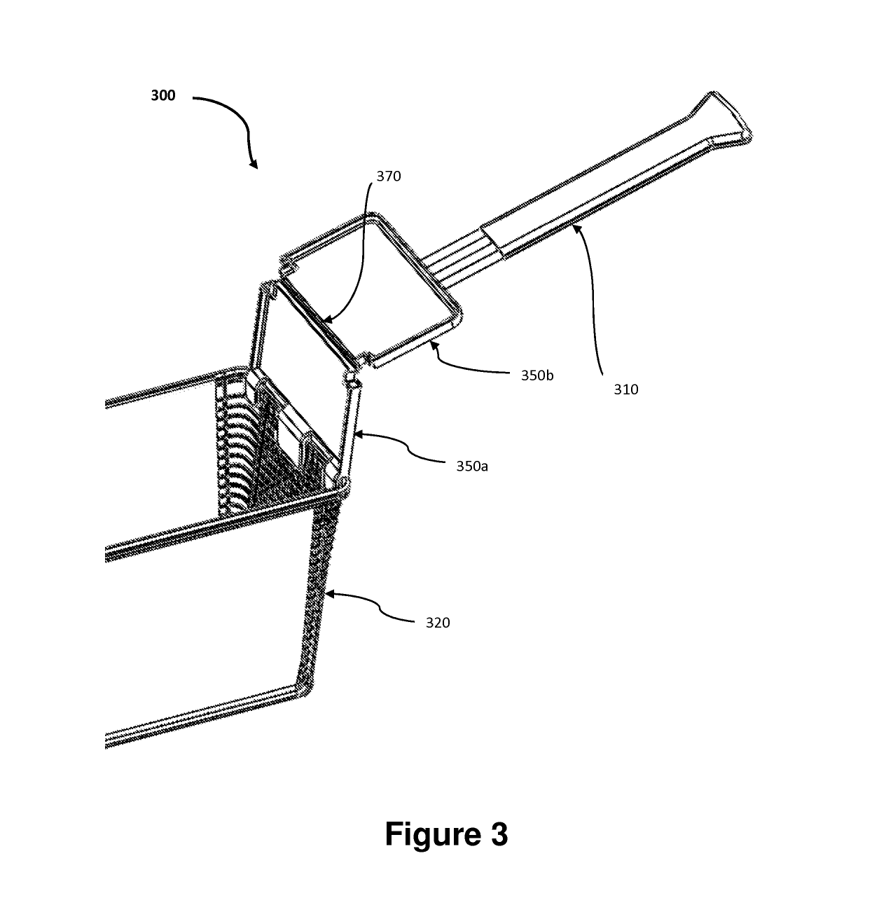

FIG. 2A shows a partial front view of a shielded frying basket 200a. In FIG. 2A, an exemplary foldable oil shield that comprises a fixed part 250a and a folding part 250b, is detachably/removably/temporarily attached to basket/container 220 by flexible, elastic, or spring-loaded clamps 260. (The word “fixed” is used to indicate that once attached, part 450a does not move with respect to the frying basket.) The fixed part 250a of the oil shield is clamped to the edge 230 of basket 220 to form a wall between handle 210 and basket 220. This wall need not be made of solid material and may be perforated itself, similar to the perforated sheets used in pan-cover or splatter-screens that are used to cover skillets and frying pans. In such embodiments the user can see through the protective wall and still be protected from flying hot liquid. In this embodiment the folding part 250b of the oil shield may be kept in the same plane as the fixed part 250a or may be turned around axis 270 to stay closer or on the handle 210, as shown in FIG. 3. In various embodiments the oil shield may be made of one piece and no part of the oil shield may rotate with respect to the other part. In some embodiments a single-piece sheet may be bent to create two parts 250a and 250b in two different planes but fixed with respect to each other. In other embodiments similar oil shields may be placed on more than one side of the oil shield.

In the embodiment shown in FIG. 2A, different known mechanisms 280 may help the folding part 250b of the oil shield to stay at any desired position with respect to the fixed part 250a. In various embodiments, mechanisms 280 may act as hinges and/or even as position-locking mechanisms. In some embodiments clamps 260 may be made from metal, plastic, or any other material suited for making a semi-rigid clamps that can grab edge 230 as a result of an elastic deformation.

FIG. 2B shows a partial back view of the shielded frying basket 200b. In FIG. 2B, an exemplary foldable oil shield that comprises a fixed part 250a and a folding part 250b, is detachably/removably/temporarily attached to basket 220 by flexible, spring-loaded or elastic clamps 265. The fixed part 250a of the oil shield is clamped to edge 230 of basket 220 to form a protective wall between handle 210 and basket 220. In this embodiment the folding part 250b of the oil shield may be kept in the same plane as the fixed part 250a or may be turned around axis 270 to stay closer or on the handle 210. In this embodiment additional clamps 275 are also used to clamp the fixed part 250a of the oil shield to handle 210. In various embodiments the folding part 250b of the oil shield may also have one or more clamps similar to clamp 275 to be attached to handle 210 while being folded and placed on the handle 210.

In the embodiment shown in FIG. 2B, different known mechanisms 280 may help the folding part 250b of the oil shield to stay at any desired position with respect to the fixed part 250a. In various embodiments, mechanisms 280 may act as hinges and/or even as position-locking mechanisms. In some embodiments clamps 265 may be made from metal, plastic, or any other material suited for making clamps that can grab and attach to edge 230.

FIG. 3 illustrates a shielded frying basket 300 with a foldable oil shield. In FIG. 3 the foldable part 350b of the oil shield is turned around axis 370 and is placed over handle 310. The fixed part 350a of the oil shield is clamped to the edge of basket/container 320 to form a protective wall between handle 310 and basket 320 and to prevent any hot liquid to splash to the hand of a user holding handle 310. A folded shield as shown in FIG. 3 makes it easy to stack the baskets inside each other and provides a better field of view of the food within the basket.

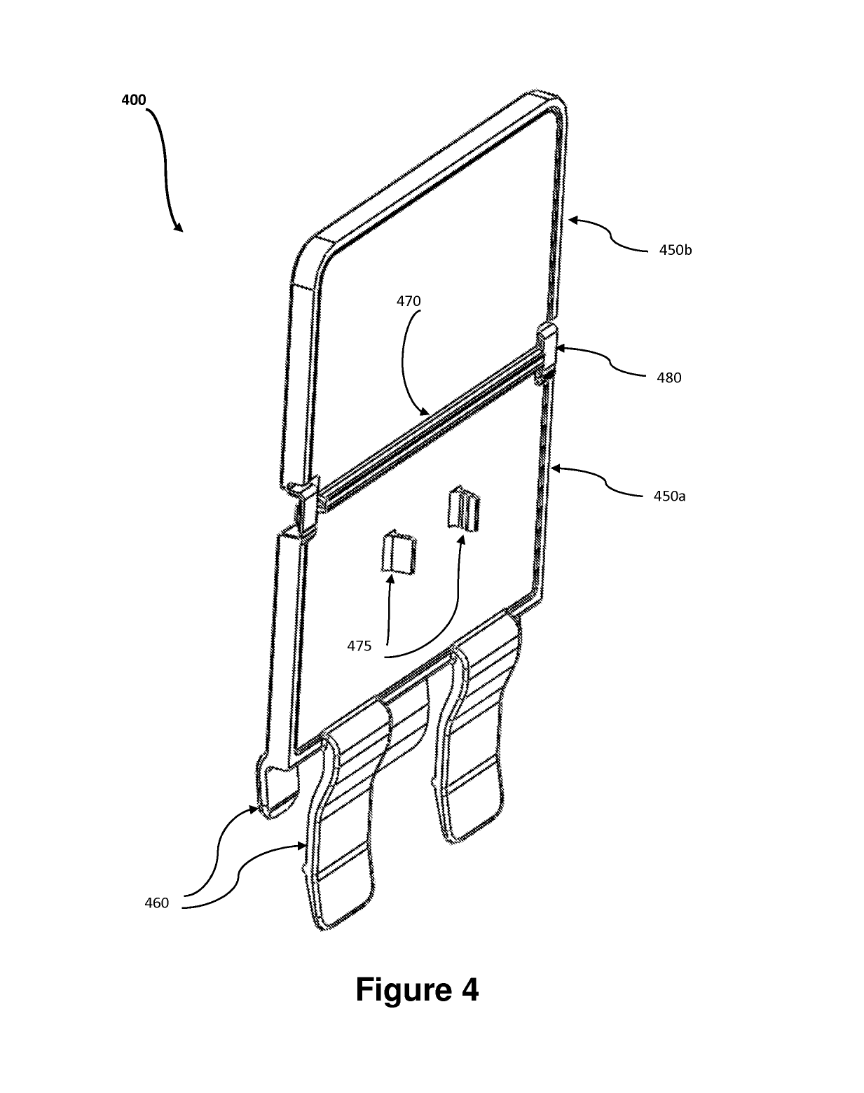

FIG. 4 is an isometric view of an example foldable oil shield 400. In this embodiment solid or spring-loaded clamps 460, which are used to attach the oil shield 400 to the frying baskets, are attached to or are a part of the fixed part 450a of the oil shield 400. In this embodiment additional clamps 475 are used to also clamp the fixed part 450a of the oil shield 400 to the basket handle. In various embodiments the folding part 450b of the oil shield may also have clamps similar to clamp 475 to be attached to the basket handle while folded and on the basket handle. As shown in FIG. 4, the entire axis of rotation 470 of the folding part 450b with respect to the fixed part 450a may be a hinge or multiple hinges made from plastic or metal or other materials. In this embodiment the hinge is simply made of a thin plastic sheet that is attached or is a part of the fixed part 450a and folding part 450b.

In the embodiment shown in FIG. 4, different known mechanisms 480 may help the folding part 450b of the oil shield 400 to stay at any desired position with respect to the fixed part 450a. In various embodiments, mechanisms 480 may act as hinges and/or even as position-locking mechanisms. In some embodiments clamps 460 may be made from metal, plastic, or any other material suited for making clamps that can grab an edge of the frying basket.

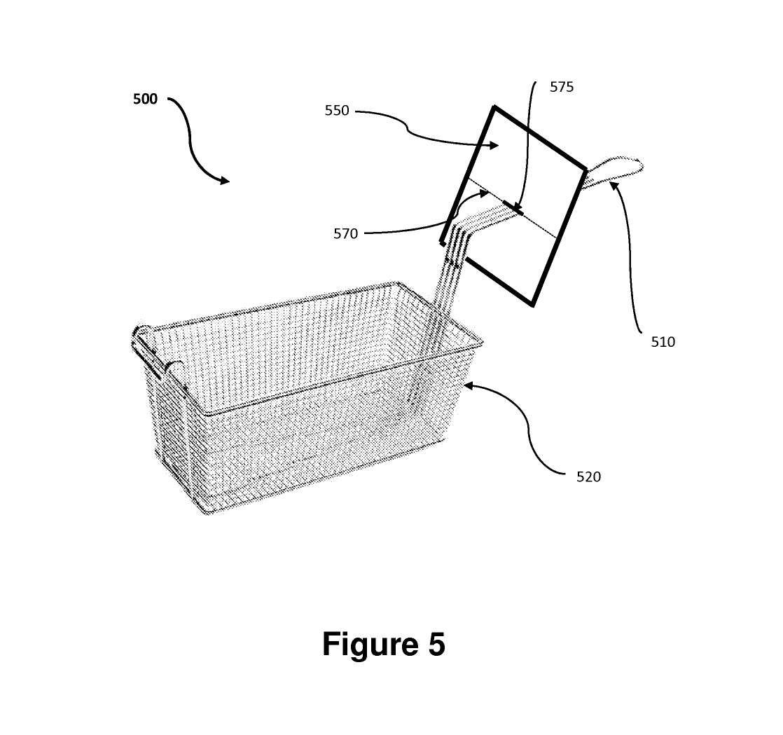

FIG. 5 shows an isometric view of a shielded fryer basket 500. In this embodiment the oil shield 550 is similar to the cross-guard of a sword and may be foldable where the top and the bottom parts of the oil shield 550 rotate around axis 570 with respect to each other, as illustrated in FIG. 3, or be non-foldable and be made of, for example, a single sheet of hard plastic or metal. In the embodiment of FIG. 5 handle 510 passes through the opening 575. In other embodiments opening slot 575 may continue to one edge of the shield 550 to allow handle 510, which is attached to basket/container 520, to enter the shield 550 sideways. In some foldable embodiments the top part of shield 550 may also have small clamps, similar to clamps 275. In some embodiments a single-piece sheet of material may be bent into two different planes, such that one plane can be placed on the handle 510 while the other acts as a protective wall.

In various embodiments the oil shield may be as tall and as wide as desired to even block hot liquid drops flying from outside and around the frying basket toward the user's hand. Oil shields disclosed above may be placed on any side of the frying baskets even if they do not protect the handle; however, it is preferable to use the oil shields to at least protect the handle from splattering fluid.

Various principles of the present invention have been described in exemplary embodiments. However, many combinations and modifications of the above-described structures, arrangements, proportions, elements, materials, and components, used in the practice of the invention, in addition to those not specifically described, can be varied without departing from those principles. Various embodiments have been described as comprising automatic processes, but these processes may be performed manually without departing from the scope of the present invention.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A shielded deep frying basket comprising:
a deep frying basket that has a handle and a container;
a one-piece or multiple-piece oil shield; and
wherein the one-piece or multiple-piece oil shield is permanently or detachably attached to the deep frying basket container such that the oil shield forms a protective wall on the path of a drop of hot fluid flying outward from inside of the basket container.

2. The shielded deep frying basket of claim 1, wherein the multiple-piece oil shield is foldable.

3. The shielded deep frying basket of claim 1, wherein the oil shield has clamps to be attached to an edge of the deep fryer basket container or to the handle or to both.

4. The shielded deep frying basket of claim 1, wherein the oil shield is placed at any location around the basket container.

5. The shielded deep frying basket of claim 1, wherein the multiple-piece oil shield has two parts and is foldable and wherein one part of the oil shield is attached to the basket container and the other part rotates with respect to the attached part.

6. The shielded deep frying basket of claim 1, wherein the oil shield is made of a bent or a substantially flat sheet of material.

7. The shielded deep frying basket of claim 1, wherein the oil shield is made of plastic, metal, wood, or any other natural or synthetic material.

8. The shielded deep frying basket of claim 1, wherein the oil shield also attaches, permanently or removably, to the handle.

9. A shielded deep frying basket comprising:
a deep frying basket that has a handle and a container;
a one-piece or multiple-piece oil shield; and
wherein the one-piece or multiple-piece oil shield is permanently or detachably attached to the deep frying basket handle such that the oil shield forms a protective wall on the path of a drop of hot fluid flying outward from inside or surrounding of the basket container.

10. The shielded deep frying basket of claim 9, wherein the multiple-piece oil shield is foldable.

11. The shielded deep frying basket of claim 9, wherein the oil shield has slots through which the handle passes.

12. The shielded deep frying basket of claim 9, wherein the oil shield has clamps to be attached to the handle.

13. The shielded deep frying basket of claim 9, wherein the multiple-piece oil shield has two parts and is foldable and wherein one part of the oil shield is attached to the handle.

14. The shielded deep frying basket of claim 9, wherein the oil shield is made of a substantially flat or a bent sheet of material.

15. The shielded deep frying basket of claim 9, wherein the oil shield is made of plastic, metal, wood, or any other natural or synthetic material.

16. The shielded deep frying basket of claim 9, wherein the oil shield is made of a solid or a perforated material.

17. An oil shield for deep frying baskets, the oil shield comprising:
a one-piece or multiple-piece of substantially flat sheet of material, wherein the one-piece or multiple-piece oil shield is permanently or removably attachable to at least one side of deep frying basket containers and/or deep frying basket handles such that the oil shield forms a protective wall on the path of a drop of hot fluid flying from inside or surrounding of the deep frying baskets toward a user's hand that is holding the handle.

18. The oil shield of claim 17, wherein the oil shield includes one or more clamps to be attached to the basket container, the basket handle or both.

19. The oil shield of claim 17, wherein the multiple-piece oil shield is foldable or non-foldable.

20. The oil shield of claim 17, wherein the one-piece oil shield is made of a substantially flat or bent sheet of material.
